(19) United States
(12) Patent Application Publication
(10) Pub. No.: US 2025/0297588 A1
(43) Pub. Date: Sep. 25, 2025

(54) Gaseous Fuel Mixing Block

(71) Applicant: Hydrogen Energy Systems, LLC, Akron, OH (US)

(72) Inventors: Rick M. Saccone, Uniontown, OH (US); Jeffrey E. Wilhite, Cuyahoga Falls, OH (US)

(21) Appl. No.: 19/074,773

(22) Filed: Mar. 10, 2025

Related U.S. Application Data
(60) Provisional application No. 63/563,652, filed on Mar. 11, 2024.

(51) Int. Cl. F02M 21/04; F02M 21/02

(52) U.S. Cl. CPC F02M 21/04; F02M 21/0233; F02M 21/0242

(57) ABSTRACT

An apparatus for providing a fuel mixture to an internal combustion engine includes a mixing block. A bore is defined through the mixing block; and a fuel distribution chamber extends from the bore between the inlet side and the outlet side of the mixing block. A flow controller including: a valve including a seat, needle, and stem, defining a flow path configured to throttle flow between the fuel distribution chamber and the bore; a throttle control mechanism configured to translate the stem and needle toward or away from the seat; and a biasing mechanism biasing the throttle control mechanism; a first gas shutoff configured to permit fuel to flow from a first pressurized fuel manifold into the fuel distribution chamber; and a second gas shutoff configured to permit fuel to flow from a second, higher pressure fuel manifold into the fuel distribution chamber.

### CROSS-REFERENCE TO RELATED APPLICATIONS

This application claims the benefit of priority to U.S. Application No. 63/563,652, filed on Mar. 11, 2024, the contents of which are incorporated by reference herein.

### TECHNICAL FIELD

This disclosure generally relates to a mixing block for delivering a gaseous fuel and air mixture to an internal combustion engine.

### BACKGROUND

Internal combustion engines require a mixture of fuel and air to function correctly. In traditional systems, a carburetor can be used, which atomizes and mixes a liquid fuel with air to provide a suitable fuel/air mix. However, when the fuel is a pressurized gas, the conventional carburetor is insufficient.

### SUMMARY

In an aspect, an apparatus for providing a fuel mixture to an internal combustion engine includes a mixing block. A bore is defined through the mixing block between an inlet side and an outlet side of the mixing block; and a fuel distribution chamber is defined in the mixing block, wherein the fuel distribution chamber extends from the bore between the inlet side and the outlet side of the mixing block. The apparatus includes a flow controller including: a valve including a seat, needle, and stem, wherein when the needle and seat define a flow path configured to throttle flow between the fuel distribution chamber and the bore, and wherein the stem is coupled to the needle; a throttle control mechanism coupled to the stem and configured to translate the stem and needle toward or away from the seat; and a biasing mechanism biasing the throttle control mechanism; a first gas shutoff configured to permit gaseous fuel to flow from a first pressurized fuel manifold into the fuel distribution chamber; and a second gas shutoff configured to permit gaseous fuel to flow from a second pressurized fuel manifold into the fuel distribution chamber, the second pressurized fuel manifold at a higher pressure than the first fuel manifold.

Embodiments can include one or any combination of two or more of the following features.

Each of the first gas shutoff and the second gas shutoff includes a solenoid operated valve. In some cases, each of the solenoid operated valves include a vacuum activated switch electrically connected to the respective solenoid. In some cases, the vacuum activated switch is connected to a vacuum port fluidically connected to the bore between a slider and the outlet side of the mixing block.

The throttle mechanism includes a bell crank connected to the stem.

The apparatus includes a stopper moveable between a first position and a second position, wherein more of the stopper extends into the bore when the stopper is in the first position than when the stopper is in the second position.

In a general aspect, combinable with the foregoing aspect, a method for providing a fuel mixture to an engine includes receiving air into an inlet of a bore defined through a mixing block, wherein an outlet of the bore is connected to the engine; based on a speed of the engine, activating (i) a low pressure gaseous fuel shutoff to permit a low pressure gaseous fuel to flow into a lower control chamber defined in the mixing block or (ii) a high pressure gas shutoff to permit a high pressure gaseous fuel to flow into the lower control chamber, wherein the lower control chamber extends from the bore in a first direction; mixing the gas with the air in the bore to form the fuel mixture. A a flow of the fuel mixture through the bore and a flow of the gas through the lower control chamber is throttled by a flow controller including: a first slider that is slidably disposed in an upper control chamber and configured to slide into the bore, wherein the upper control chamber is aligned with the lower control chamber and extends from the bore in a second direction opposite the first direction, a second slider connected to the first slider and slidably disposed in the lower control chamber, and a biasing mechanism biasing the first slider.

Implementations can include one or more of the following advantages. The mixing block can be a purely mechanical system which requires little or no digital or computer inputs to operate. The disclosed mixing block can flexibly operate on multiple gaseous fuels such as hydrogen, natural gas, methane, or a combination thereof. The disclosed mixing block can be used to retrofit existing internal combustion engines, enabling the use of new fuel types in conventional engines. The disclosed mixing block is capable of operating over a wide range of powers and demands. This is possible in part because of the dual solenoid fuel supply.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

In general, this disclosure relates to wheel hub disconnects

FIG. 1 is a perspective view of a gaseous fuel mixing block.

FIGS. 2A and 2B illustrate operation of an example throttle mechanism for a gaseous fuel mixing block.

FIG. 3 is a partial cut-away diagram illustrating internal flow paths of a gaseous fuel mixing block.

FIG. 4 is a flowchart illustrating an example process for operating a gaseous fuel mixing block.

FIG. 5 is a system diagram illustrating an example architecture utilizing a gaseous fuel mixing block.

### DETAILED DESCRIPTION

This disclosure describes a mixing block for adding gaseous fuel to air at the intake of an internal combustion engine. Two solenoid valves can be used to isolate or permit pressurized gas to flow through a throttle valve and into a mixing chamber in order to generate a fuel/air mixture suitable for the internal combustion engine. Each of the two solenoid valves can provide pressurized fuel at a different pressure, such that one solenoid can be used during high speed/high fuel demand operations, while the other solenoid can be used during low speed/low fuel demand operations.

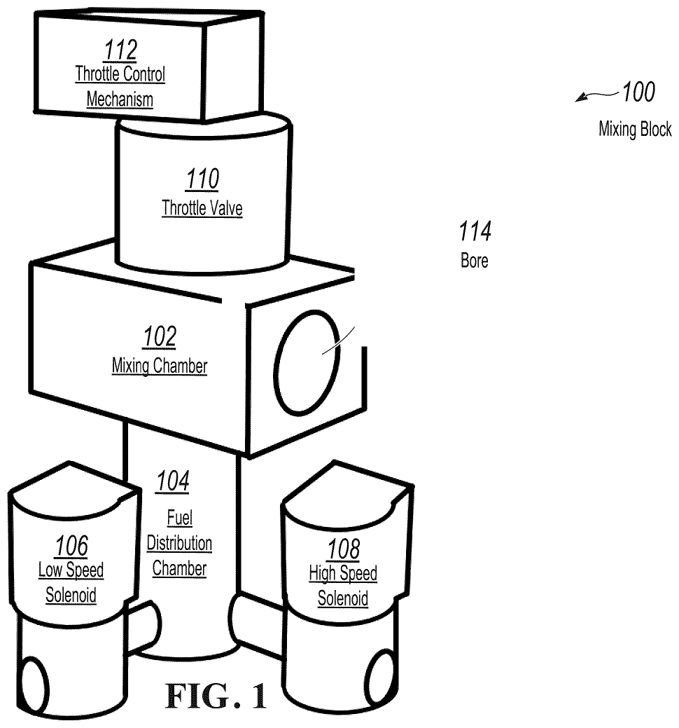

FIG. 1 is a perspective view of a gaseous fuel mixing block. A mixing chamber 102 includes a bore 114 that has an inlet and outlet and allows air to pass (e.g., from an induction system of a vehicle) into the mixing chamber 102, where fuel is introduced from the fuel distribution chamber 104 before the fuel air mixture continues to an engine intake.

Fuel distribution chamber 104 can include a plenum or interior volume that is supplied with fuel from either or both of the low speed solenoid 106 and the high speed solenoid 108. In some implementations both solenoids isolate fuel from a common fuel source. For example, a pressurized container of hydrogen gas can provide fuel storage. The pressurized hydrogen can be routed directly to the high speed solenoid 108, and also to the low speed solenoid 106 through a gas regulator or reducer, resulting in a lower pressure at the low speed solenoid 106 than the high speed solenoid 108. In some implementations, two separate fuel, storage systems can be used, for example, two different pressurized containers at different pressures. In some implementations each solenoid can deliver different fuels to the fuel distribution chamber 104. For example, the low speed solenoid 106 can deliver methane gas, while the high speed solenoid 108 delivers hydrogen.

Low speed solenoid 106 and high speed solenoid 108 can be solenoid operated valves that are, for example, spring biased in a shut direction. That is, with no applied voltage, the solenoid valves default to a shut, or isolated position. When an electrical current, or voltage (e.g., 12V DC) is applied to a solenoid, it can act as an electromagnet, opening a valve, and permitting pressurized fuel to flow into the fuel distribution chamber 104.

A throttle valve/slider 110 can extend from the top of the mixing chamber 102 through the bore 114 and align with or mate to a seat at the bottom of the mixing chamber 102, controlling or regulating flow from the fuel distribution chamber 104 to the mixing chamber 102, as well as airflow through the bore 114 from the air intake to the engine intake.

The throttle valve/slider 110 can be controlled by a throttle control mechanism 112, which can be, for example, a servo motor, cable push/pull system (e.g., a Bowden cable), rack and pinion or other gear system, or a combination thereof. In some implementations the throttle valve/slider 110 is biased or spring loaded, and a combination cable and bell crank system is used as a throttle control mechanism 112.

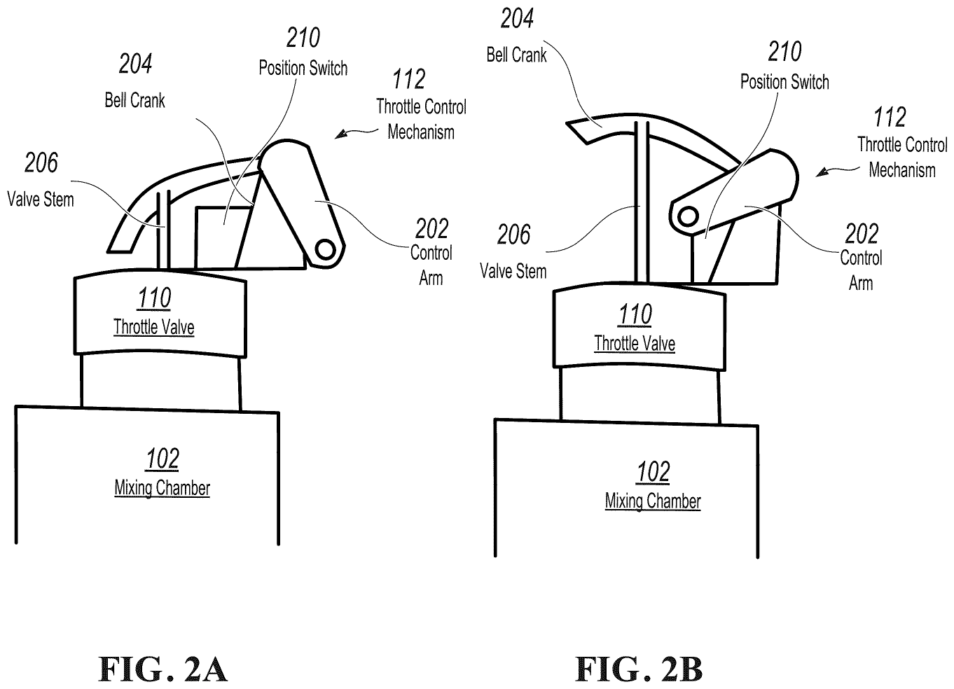

FIGS. 2A and 2B illustrate operation of an example throttle mechanism for a gaseous fuel mixing block. The throttle mechanism 112 includes a control arm 202, bell crank 204, needle stem 206, and position switch 210.

The control arm 202 can provide a lever for a cable or other mechanism to rotate the bell crank 204. In some implementations, the bell crank 204 is spring loaded, that is, it is connected to a cylinder or other mechanism that is biased in a particular direction. In some implementations, the bell crank 204 and throttle control mechanism 112 in general relies on a spring or bias built into another component of the mixing block (e.g., throttle valve 110/slider). FIG. 2A illustrates the throttle control mechanism 112 in a shut configuration, while in FIG. 2B, the control arm 202 has been rotated (clockwise), lifting the bell crank 204, which raises the needle stem 206, opening the associated throttle valve 110/slider and allowing more fuel to pass into the mixing chamber 102.

A position switch 210 can be provided to generate mechanical or electrical signals based on the position of the throttle valve/slider 110 or throttle control mechanism 112. In some implementations, the position switch 210 includes one or more hall effect sensors, that detect a position of the bell crank 204 based on changes in magnetic inductance caused by the presence of the bell crank 204. In some implementations, the position switch 210 includes one or more encoders, that measure the amount of rotation of the control arm 202.

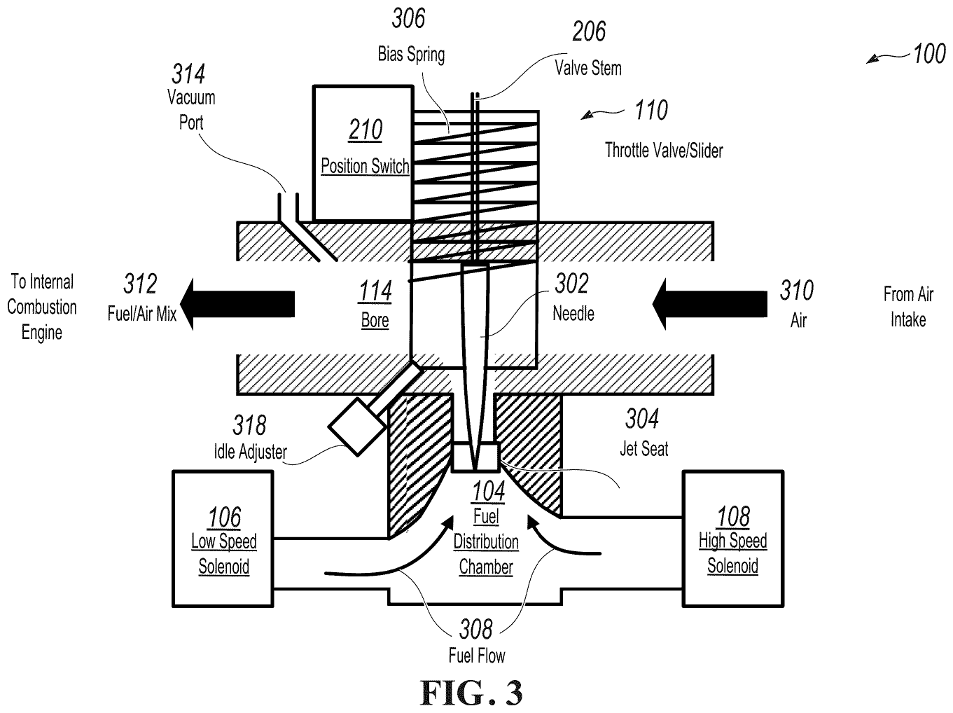

FIG. 3 is a partial cut-away diagram illustrating internal flow paths of a gaseous fuel mixing block. Illustrated in FIG. 3 is the throttle valve/slider 110 which includes a needle 302, jet seat 304, bias spring 306, and needle stem 206. The needle 302 has a tapered shape which facilitates achieving a target fuel/air ratio. FIG. 3 also illustrates various fluid flows within mixing block 100 including fuel flow 108, air flow 310, and fuel/air mix flow 312. Some additional, optional features may be included, such as an idle bypass (not shown), as well as a vacuum port 314.

The needle 302 is raised and lowered within the bore 114 by the needle stem 206 (which can be operated by a throttle control mechanism such as the throttle control mechanism 112 as illustrated in FIGS. 2A and 2B). When lowered, the needle 302 mates with the jet seat 304, or generally reduces a volume between the needle 302 and jet seat 304, restricting flow from the fuel distribution chamber 104 into the bore 114. When raised, the fuel flow is less restricted, and therefor increases, providing a richer fuel air mix 312. In some implementations the needle 302 also provides throttling of air flow 310. For example, needle 302 can include a barrel or cap shape near the needle stem 206 that retracts into the throttle valve/slider 110 as the needle stem 206 is raised but protrudes into the bore 114 as the stem is lowered. Additionally, actuation of an idle adjuster 318, which can be a screw or a plug, raises or lowers the slider 110 to provide more or less air or gas in the fuel air mix 312.

Position switch 210 can provide electrical or mechanical signals indicating the throttle position, or the commanded fuel/air mix 312 that is desired. These electrical or mechanical signals can be used to trigger low speed solenoid 106 and high speed solenoid 108 in order to regulate a pressure or fuel flow 308 through the fuel distribution chamber 104 and ensure sufficient mixture of fuel and air in the bore 114.

In some implementations an idle bypass is provided, which provide a flow path for a relatively small amount of fuel to enter the bore 114 regardless of the position of the throttle valve/slider 110. That is, when the throttle valve/slider 110 is fully shut, some fuel can still enter the bore 114 by the idle bypass, which can provide a certain amount of fuel required to maintain the internal combustion engine idling. An idle adjuster, such as a screw or plug, protrudes into the idle bypass, enabling adjustment of the amount of fuel used by the idle bypass.

A vacuum port 314 can be provided which draws a negative pressure on any connected tubes or sensors. In some implementations the vacuum port 314 is used as an alternative to the position switch 210 sensing a “demand” from the internal combustion engine, or indirectly determining the throttle position. In some implementations the vacuum port 314 is used to augment position switch 210 in control of the mixing block 100 including it's solenoids 106 and 108.

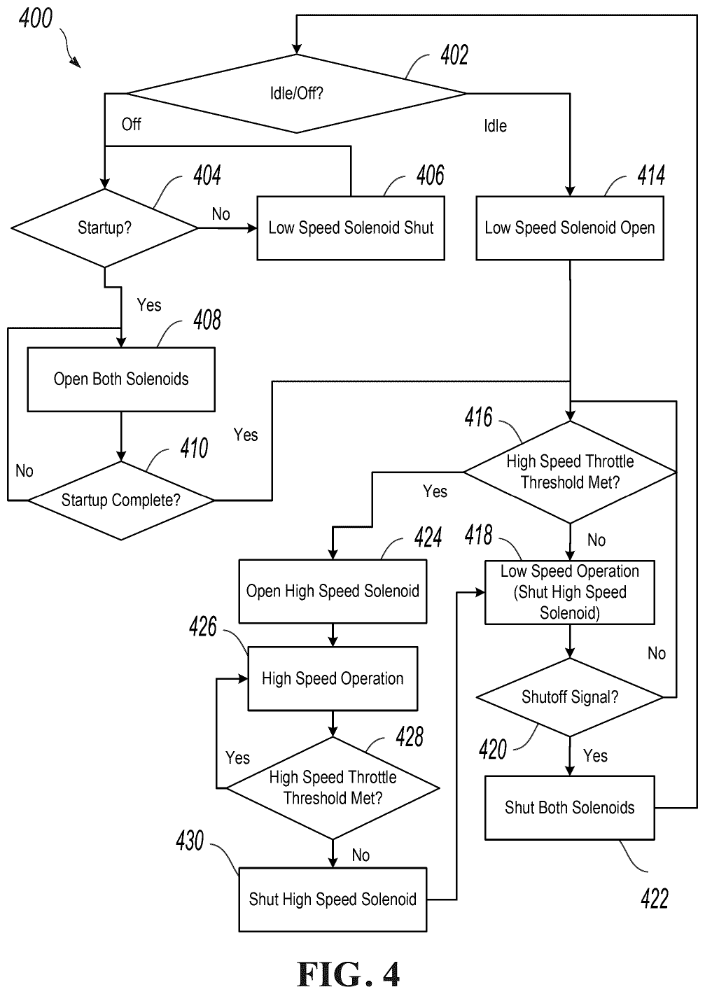

FIG. 4 is a flowchart illustrating an example process 400 for operating a gaseous fuel mixing block. In some implementations, not each element of process 400 is required, further, some elements can be performed in parallel, or in different orders. For example, while 402 is illustrated at the top as a prospective “starting point,” process 400 can be a continuous process that has no defined start or end. Or process 400 can begin at 416, and end when a shutoff signal is received. Process 400 is provided as an example algorithm for controlling the high speed solenoid and low speed solenoid of a gaseous fuel mixing block such as the mixing block 100 described above with respect to FIGS. 1-3. It should be noted however, that process 400 is only an exemplary process, and other processes or control algorithms are possible.

In some implementations, process 400 is implemented using a microcontroller or programmable computer as well as various sensors. For example, and engine control unit (ECU) can perform process 400. In some implementations, process 400 is implemented by a distributed array of electronic circuits and mechanical devices. For example, a particular integrated circuit chip can be used to perform 420, while 426 can represent the operation of the mechanical engine/mixing block system as a whole.

At 402, it is determined whether the engine is in an idle state or an off state. Idle state is a minimum fuel flow state where the engine is running, but not being used to provide any significant torque or power. In many implementations, when the engine is not needed, it can be turned off instead of allowed to idle, to save fuel and reduce wear. If it is determined that the engine is off, process 400 proceeds to 404, otherwise if it is determined that the engine is idling, process 400 proceeds to 414.

At 404, a check is performed to determine if a startup command has been received. If no startup command is received, the engine is to remain off, process 400 proceeds to 406 where the low speed solenoid is shut or verified shut, process 400 can then return to 404 where continued monitoring for a start-up signal can occur.

When a start-up signal is received, process 400 proceeds to 408, where both the high speed and low speed solenoid are opened to provide a fuel rich environment during start up operations.

At 410, certain engine parameters are monitored to determine whether the startup is complete. These parameters can be, engine speed, engine temperature, oil temperature, coolant temperature, throttle position/demand, electrical demand (where the engine powers an electrical generator) or other parameters. Once startup is complete process 400 proceeds to 416.

Returning to 414, where the engine is determined to be idle, the low speed solenoid valve is opened to permit some fuel to enter into the engine and maintain it in a running state.

At 416, a throttle position or demand signal is identified and used to determine if the demand exceeds a predetermined threshold. For example, if the throttle position is greater than 25% of full travel, or if the engine RPM is above a specified speed (e.g., 3000, or 5000 RPM, etc.) process 400 can proceed to 424. If the high speed throttle threshold is not satisfied process 418 can continue or return to low speed operation at 418.

At 424, when the high speed threshold is satisfied, the high speed solenoid is opened. This allows additional fuel, at a higher pressure to enter the fuel distribution chamber and thus increases the fuel flow into the mixing block, allowing for a better mixture during high flow operations. Process 400 then proceeds to 426 where high speed operation occurs.

At 428, the high speed throttle threshold is monitored, if the threshold is still satisfied, process 400 remains at 426, and high speed operation continues. If the threshold is not satisfied, process 400 proceeds to 430. It should be noted that the threshold at 428 and the threshold at 416 are not necessarily the same. For example, the threshold for leaving high speed operation (e.g., 428) can be lower than the threshold for entering it (416), which can create a bistable effect, and eliminate rapid state switch or excessive cycling of solenoids. In another example, as fuel pressure in the fuel distribution chamber changes, the throttle position may be changed to compensate. As a result, the threshold for toggling the high speed solenoid may change based on the current state of operations.

At 430, the high speed solenoid is shut, and process 400 returns to 418, where low speed operation occurs.

At 420, a check is performed for a shutoff signal. If no such signal is received then process 400 returns to 416 where it is again determined whether the high speed throttle threshold is met. Otherwise, if a shutoff signal is received, process 400 proceeds to 422. The shutoff signal can be an electric signal provided by one or more sensors, or the lack of a signal (e.g., lack of an ignition signal).

At 422, when the shutoff signal is received, both the high speed and the low speed solenoids can be shut, isolating the fuel supply from the mixing block and stopping the engine.

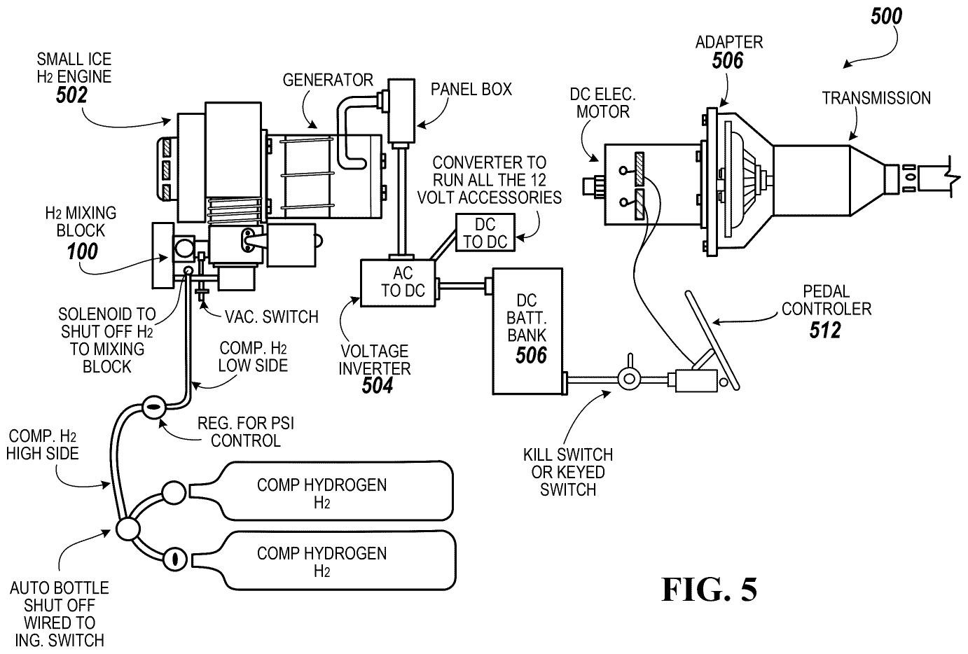

FIG. 5 is a system diagram illustrating an example architecture 500 utilizing a gaseous fuel mixing block. The gaseous mixing block 100 (labeled as a hydrogen mixing block in the illustrated example) receives gaseous fuel from compressed gas containers 508, and provides it to an internal combustion engine/generator 502, which converts the fuel into electrical energy which is inverted at voltage inverter 504 and stored in a battery bank 506. One or more controls 512, which can be user operated or computer operated (e.g., by a vehicle ECU) can adjust the power transfer from the battery bank 506 to the electric powertrain 510 during operation of the vehicle.

The compressed gas containers 508 can store gaseous fuel such as hydrogen, methane, propane, or other fuel in a gas, liquid, or mixed state. The fuel can be stored at a variety or pressures, and in some implementations regulated to a predetermined pressure before supplying mixing block 100.

In the illustrated example, internal combustion engine/generator 502 receives a fuel/air mixture from mixing block 100 and combusts it to rotate a drive shaft that acts as a prime mover in the generator portion. The generator portion then produces AC electrical power. In some implementations, the drive shaft can power additional auxiliary equipment such as vacuum pumps, switches, or even vehicle propulsion components (e.g., the vehicle drive shaft).

Voltage inverter 504 converts the AC output of the generator 502 into a DC power supply which is suitable for charging the battery bank 506, or in some implementations, powering the electric powertrain 510.

In the illustrated example, the electric powertrain 510 includes a DC electric motor, transmission, and output shaft. In some implementations, electric powertrain 510 includes an AC motor, or is direct drive (e.g., does not include a transmission, or significant reduction in the transmission).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations, but is to be accorded the widest scope consistent with the principles and features disclosed herein.

1. An apparatus for providing a fuel mixture to an internal combustion engine, the apparatus comprising:
a mixing block, wherein:
a bore is defined through the mixing block between an inlet side and an outlet side of the mixing block; and
a fuel distribution chamber defined in the mixing block, wherein the fuel distribution chamber extends from the bore between the inlet side and the outlet side of the mixing block;
a flow controller comprising:
a valve comprising a seat, needle, and stem, wherein when the needle and seat define a flow path configured to throttle flow between the fuel distribution chamber and the bore, and wherein the stem is coupled to the needle;
a throttle control mechanism coupled to the stem and configured to translate the stem and needle toward or away from the seat; and
a biasing mechanism biasing the throttle control mechanism;
a first gas shutoff configured to permit gaseous fuel to flow from a first pressurized fuel manifold into the fuel distribution chamber; and
a second gas shutoff configured to permit gaseous fuel to flow from a second pressurized fuel manifold into the fuel distribution chamber, the second pressurized fuel manifold at a higher pressure than the first fuel manifold.

2. The apparatus of claim 1, wherein each of the first gas shutoff and the second gas shutoff comprises a solenoid operated valve.

3. The apparatus of claim 2, wherein each of the solenoid operated valves comprise a vacuum activated switch electrically connected to the respective solenoid.

4. The apparatus of claim 3, wherein the vacuum activated switch is connected to a vacuum port fluidically connected to the bore between a slider and the outlet side of the mixing block.

5. The apparatus of claim 1, wherein the throttle mechanism comprises a bell crank connected to the stem.

6. The apparatus of claim 1, comprising a stopper moveable between a first position and a second position, wherein more of the stopper extends into the bore when the stopper is in the first position than when the stopper is in the second position.

7. A method for providing a fuel mixture to an engine, the method comprising:
receiving air into an inlet of a bore defined through a mixing block, wherein an outlet of the bore is connected to the engine;
based on a speed of the engine, activating (i) a low pressure gaseous fuel shutoff to permit a low pressure gaseous fuel to flow into a lower control chamber defined in the mixing block or (ii) a high pressure gas shutoff to permit a high pressure gaseous fuel to flow into the lower control chamber, wherein the lower control chamber extends from the bore in a first direction;
mixing the gas with the air in the bore to form the fuel mixture;
wherein a flow of the fuel mixture through the bore and a flow of the gas through the lower control chamber is throttled by a flow controller comprising:
a first slider that is slidably disposed in an upper control chamber and configured to slide into the bore, wherein the upper control chamber is aligned with the lower control chamber and extends from the bore in a second direction opposite the first direction,
a second slider connected to the first slider and slidably disposed in the lower control chamber, and
a biasing mechanism biasing the first slider.
